(19) United States
(12) Patent Application Publication
(10) Pub. No.: US 2015/0103150 A1
(43) Pub. Date: Apr. 16, 2015

(54) INFORMATION PROCESSING METHOD AND ELECTRONIC DEVICE

(71) Applicant: LENOVO (BEIJING) CO., LTD., Beijing (CN)

(72) Inventors: Wei Ni, Beijing (CN); Qizhong Zheng, Beijing (CN)

(73) Assignee: LENOVO (BEIJING) CO., LTD., Beijing (CN)

(21) Appl. No.: 14/389,272

(22) PCT Filed: Jan. 24, 2014
(86) PCT No.: PCT/CN2014/071298

§ 371 Date: Sep. 29, 2014

(30) Foreign Application Priority Data
Jan. 30, 2013 (CN) 201310036422.X

(51) Int. Cl. H04N 13/04

(52) U.S. Cl. CPC H04N 13/0497; H04N 13/0402
USPC 348/51

(57) ABSTRACT

An information processing method and electronic device, the method comprising: displaying on a first device a first target object as a first display parameter; when the first target object is displayed as the first display parameter, a user of the electronic device can perceive a first perceptible distance to the first target object; displaying the first target object as a second display parameter at a second moment after the first moment; when the first target object is displayed as the second display parameter, the viewer can perceive a second perceptible distance to the first target object, the first perceptible distance being different from the second perceptible distance, thus solving the technical problem of single display mode of a 3D imaging device in the prior art.

This application claims the benefit to Chinese patent application No. 201310036422.X, titled “INFORMATION PROCESSING METHOD AND ELECTRONIC DEVICE” and filed with the State Intellectual Property Office on Jan. 30, 2013, which is hereby incorporated by reference in its entirety.

### FIELD

The disclosure relates to the field of electronic technologies, and particularly to an information processing method and an electronic device.

### BACKGROUND

With the development of science and technology, electronic technologies have developed rapidly and there are more and more kinds of electronic products, and therefore people enjoy conveniences brought therefrom. Nowadays, due to the development of science and technology, people can enjoy a comfortable life through various types of electronic devices.

For example, with a three dimensional (3D) television or a 3D imaging device, a viewerviewer can perceive whether a display screen is near to or far from the eyes of the viewer when viewing a video, that is, there are positive depth-of-field (DOF) and negative DOF in 3D imaging. In a case of the positive DOF, the viewer may perceive that the display screen is near to the eyes of the viewer; and in a case of the negative DOF, the viewer may perceive that the display screen is far from the eyes of the viewer, thereby making the viewer have a better visual experience and a better user experience.

However, the 3D television or the 3D imaging device can provide only one display mode, that is, the 3D imaging device has only one 3D display effect, resulting in a technical problem that the 3D imaging device has a single display mode.

### SUMMARY

The disclosure provides an information processing method and an electronic device, to solve the technical problem that the 3D imaging device has a single display mode. Specific technical solutions are as follows.

An information processing method is provided. The information processing method is applied to an electronic device containing or being connected with a display unit, where the method includes:

displaying a first target object with a first display parameter at a first time, where a first perceptible distance between a viewer and the first target object is perceptible to the viewer when the first target object is displayed with the first display parameter; and

displaying the first target object with a second display parameter at a second time after the first time, where a second perceptible distance between the viewer and the first target object is perceptible to the viewer when the first target object is displayed with the second display parameter, the first perceptible distance is different from the second perceptible distance.

Optionally, the first perceptible distance is less than a distance between the viewer and the display unit and the second perceptible distance is greater than the distance between the viewer and the display unit; or the first perceptible distance is greater than a distance between the viewer and the display unit and the second perceptible distance is less than the distance between the viewer and the display unit.

Optionally, before the displaying a first target object with a first display parameter, the method further includes:

judging whether the electronic device satisfies a first preset condition and generating a first judgment result;

generating a first execution instruction if the first judgment result indicates that the electronic device satisfies the first preset condition; and

displaying the first target object with the first display parameter at the first time in response to the first execution instruction, and switching from the first display parameter to the second display parameter and displaying the first target object with the second display parameter at the second time after the first time.

Optionally, displaying the first target object with a second display parameter at a second time after the first time includes:

judging whether the electronic device satisfies a first preset condition and generating a first judgment result;

generating a second execution instruction if the first judgment result indicates that the electronic device satisfies the first preset condition; and

displaying the first target object with the first display parameter at the first time in response to the second execution instruction and switching from the first display parameter to the second display parameter and displaying the first target object with the second display parameter at the second time after the first time.

Optionally, the switching from the first display parameter to the second display parameter includes:

switching from the first display parameter to a third display parameter and switching from the third display parameter to the second display parameter, where a third distance between the viewer and the first target object is perceptible to the viewer when the first target object is displayed with the third display parameter, the third distance is a distance between the viewer and the display unit and the third distance is between the first perceptible distance and the second perceptible distance.

Optionally, judging whether the electronic device satisfies a first preset condition includes:

detecting whether there is a first operation that indicates switching the display unit from the first display parameter to the second display parameter;

judging whether the first operation satisfies the first preset condition and generating the first judgment result; and

generating a first execution instruction which indicates switching from the first display parameter to the second display parameter once the first judgment result indicates that the first operation satisfies the first preset condition.

Optionally, in a case that the electronic device includes a first operating mode and a second operating mode, the first operating mode corresponds to the first display parameter, the second operating mode corresponds to the second display parameter, and it's perceptible to the viewer that the first target object is located between the display unit and the viewer when the electronic device operates in the second operating mode;

where judging whether the electronic device satisfies a first preset condition and generating a first judgment result includes: acquiring operation information; and judging whether the operation information satisfies the first preset condition and generating the first judgment result;

where generating a first execution instruction in a case that the first judgment result indicates that the electronic device satisfies the first preset condition includes: generating, based on the operation information, a mode switching instruction for controlling the electronic device to switch from the first operating mode to the second operating mode; and determining the first target object in the electronic device based on the operation information; and

where displaying the first target object with the first display parameter at the first time in response to the first execution instruction, and switching from the first display parameter to the second display parameter and displaying the first target object with the second display parameter at the second time after the first time includes: switching the electronic device from the first operating mode to the second operating mode based on the mode switching instruction; and in the process of switching the electronic device from the first operating mode to the second operating mode, displaying the first target object with the first display parameter at a first time and displaying the first target object with the second display parameter at a second time after the first time.

Optionally, after switching the electronic device from the first operating mode to the second operating mode based on the mode switching instruction, the method further includes:

acquiring, by an image capturing apparatus, a control operation of an operation element at a first space position, where the first space position is located within a preset range of the first target object perceived by the viewer;

judging whether the control operation satisfies a second preset condition and generating a second judgment result; and

generating a response to the control operation once the second judgment result indicates that the control operation satisfies the second preset condition.

Optionally, in a case that the electronic device includes a first operating mode and a second operating mode, the first operating mode corresponds to the first display parameter, the second operating mode corresponds to the second display parameter, and it's perceptible to the viewer that the first target object is located between the display unit and the viewer when the electronic device operates in the second operating mode, switching from the first display parameter to the second display parameter in response to the second execution instruction, and displaying the first target object with the second display parameter at a second time after the first time includes:

switching the electronic device from the first operating mode to the second operating mode in response to the second execution instruction; and

adjusting the electronic device from the first display parameter to the second display parameter and displaying the first target object with the second display parameter based on the second operating mode.

Optionally, displaying the first target object with the first display parameter at the first time, and switching from the first display parameter to the second display parameter and displaying the first target object with the second display parameter at the second time after the first time includes:

determining i temporary display parameters in adjusting from a first display parameter to the second display parameter based on the first display parameter and the second display parameter;

generating a switching instruction including the i temporary display parameters; and

switching the first target object from the first display parameter to the second display parameter step by step based on the switching instruction and the determined i temporary display parameters.

Optionally, switching the first target object from the first display parameter to the second display parameter step by step based on the switching instruction and the determined i temporary display parameters includes:

calling a display icon prestored in the electronic device; and

adjusting the prestored display icon from the first display mode to the second display mode while adjusting the first target object from the first display parameter to the second display parameter step by step to make the viewer perceive that the distance between the viewer and the first target object is switched from the first perceptible distance to the second perceptible distance.

Optionally, switching the first target object from the first display parameter to the second display parameter step by step based on the switching instruction and the determined i temporary display parameters includes:

acquiring a separation degree in each of the i temporary display parameters and an i-th separation degree in an i-th temporary display parameter; and

adjusting the separation degree between a first image and a second image of the first target object from a first separation degree to the i-th separation degree step by step based on the separation degree in each of the i temporary display parameters and the i-th separation degree to make the first target object adjusted from the first display parameter to the second display parameter step by step.

An electronic device is also provided. The electronic device contains or is connected with a display unit, and the electronic device includes:

a first adjustment unit, configured to display a first target object with a first display parameter at a first time, where a first perceptible distance between the viewer and the first target object is perceptible to a viewer when the first target object is displayed with the first display parameter; and

a second adjustment unit, configured to display the first target object with a second display parameter at a second time after the first time, where a second perceptible distance between the viewer and the first target object is perceptible to the viewer when the first target object is displayed with the second display parameter, the first perceptible distance is different from the second perceptible distance.

Optionally, the electronic device further includes:

a judging unit, configured to judge whether the electronic device satisfies a first preset condition and generate a first judgment result;

a first instruction generation unit, configured to generate a first execution instruction in a case that the first judgment result indicates that the electronic device satisfies the first preset condition; and

a response unit, configured to display the first target object with the first display parameter at the first time in response to the first execution instruction, and switch from the first display parameter to the second display parameter and display the first target object with the second display parameter at the second time after the first time.

Optionally, the second adjustment unit includes:

a judging module, configured to judge whether the electronic device satisfies a first preset condition and generate a first judgment result;

an instruction generation module, configured to generate a second execution instruction in a case that the first judgment result indicates that the electronic device satisfies the first preset condition; and

a response module, configured to display a first target object with a first display parameter at a first time in response to the second execution instruction; switch from the first display parameter to the second display parameter and display the first target object with the second display parameter at the second time after the first time.

Optionally, in a case that the electronic device includes a first operating mode and a second operating mode, the electronic device further includes:

an acquisition unit, configured to acquire operation information;

a switching instruction generation unit, configured to generate a mode switching instruction for controlling the electronic device to switch from the first operating mode to the second operating mode based on the operation information, and determine the first target object in the electronic device based on the operation information; and

a switching unit, configured to switch the electronic device from the first operating mode to the second operating mode based on the mode switching instruction; and in a process of switching the electronic device from the first operating mode to the second operating mode, display the first target object with the first display parameter at the first time and display the first target object with the second display parameter at the second time after the first time.

Optionally, in a case that the electronic device includes a first operating mode and a second operating mode, the electronic device further includes:

a response unit, configured to switch the electronic device from the first operating mode to the second operating mode, in response to the second execution instruction; and

a processing unit, configured to adjust the electronic device from the first display parameter to the second display parameter and display the first target object with the second display parameter, based on the second operating mode.

One or more embodiments provided by the disclosure have at least the technical effects or advantages as follows.

In the embodiments of the disclosure, a 3D imaging device may adjust a display unit thereof from a first display parameter to a second display parameter or from the second display parameter to the first display parameter by judging whether the 3D imaging device satisfies a preset condition and a preset switching rule, so that the viewer may perceive that the distance between the viewer and the first target object is switched between a first perceptible distance and a second perceptible distance. Therefore, the technical problem that the 3D imaging device has a single display mode is solved; further, for the 3D imaging device, multiple switching modes in 3D imaging are achieved and the display switching modes are increased, the display effect of the 3D imaging device is enhanced.

In the embodiments of the disclosure, by performing switching on multiple display parameters between the first display parameter and the second display parameter step by step, an effect of gentle 3D displaying may be obtained, so that the viewer may align with the display focus position timely, thereby reducing the difficulty in focusing when the viewer views in 3D mode and enhancing the user experience.

In the embodiments of the disclosure, by adjusting the display parameters of a control interface, the viewer may perceive a display effect that the control interface protrudes the display unit; and then the viewer may perform an operation at a first space position to achieve a control over the electronic device, thus it's achieved that the electronic device adjusts the display parameter of the display control interface. Therefore, the viewer may control the electronic device in space, the control mode and the response speed of the electronic device are improved, and the user experience is enhanced.

### BRIEF DESCRIPTION OF THE DRAWINGS

FIG. 1 is a flowchart of an information processing method according to an embodiment of the disclosure;

FIG. 2 is a first schematic diagram showing a positive DOF display mode according to an embodiment of the disclosure;

FIG. 3 is a schematic diagram showing an adjustment from a first display parameter to a second display parameter according to an embodiment of the disclosure;

FIG. 4 is a second schematic diagram showing a positive DOF display mode according to an embodiment of the disclosure;

FIG. 5 is a schematic diagram showing display icons displayed with a first separation degree according to an embodiment of the disclosure;

FIG. 6 is a schematic diagram showing display icons displayed with a second separation degree according to an embodiment of the disclosure; and

FIG. 7 is a schematic structural diagram of an electronic device according to an embodiment of the disclosure.

### DETAILED DESCRIPTION

The disclosure provides an information processing method and an electronic device. The method includes: displaying a first target object with a first display parameter at a first time, where a first perceptible distance between a viewer and the first target object is perceptible to the viewer when the first target object is displayed with the first display parameter; and displaying the first target object with a second display parameter at a second time after the first time, where a second perceptible distance between the viewer and the first target object is perceptible to the viewer when the first target object is displayed with the second display parameter, the first perceptible distance is different from the second perceptible distance.

In brief, the electronic device is a 3D imaging device, and the electronic device can adjust the display parameters of the display unit of itself to make the viewer perceive that the distance from the viewer to the first target object on a display unit of the electronic device is switched between the first perceptible distance and the second perceptible distance. That is, the viewer can perceive different positions of the first target object in space.

In the following, technical solutions of the disclosure will be illustrated in detail in conjunction with the drawings and specific embodiments. It should be understood that, the embodiments of the disclosure and specific technical features in the embodiments are just used for giving detail description of the technical solutions of the disclosure rather than limiting the technical solutions of the disclosure. Therefore, the embodiments of the disclosure and the specific technical features in the embodiments may be combined with each other without conflict.

In the embodiments of the disclosure, there are two different ways to adjust the display parameters of the display unit.

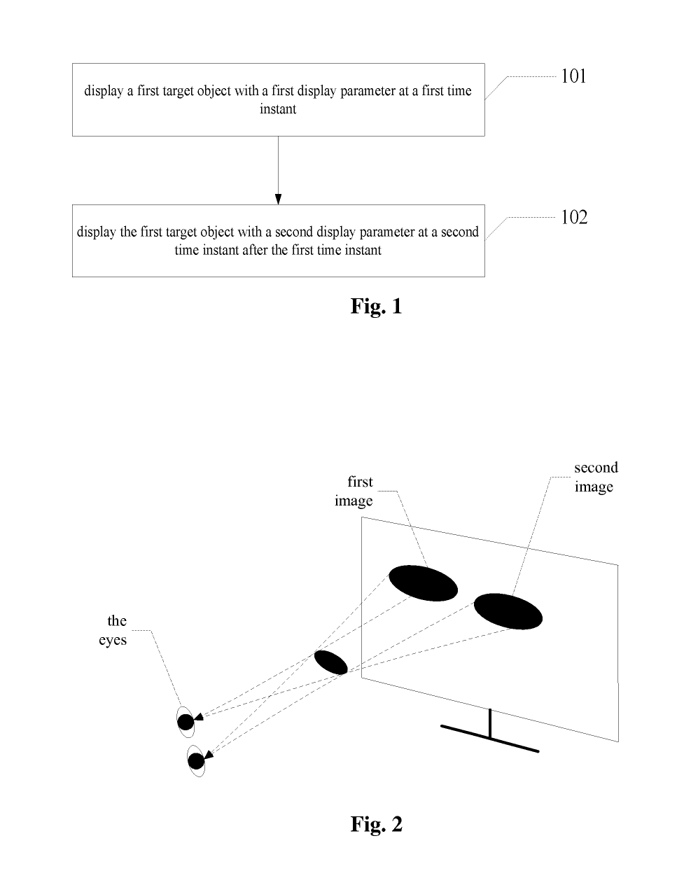

In a first way, reference is made to FIG. 1 which is a flowchart of an information processing method according to an embodiment of the disclosure, the method includes steps 101 and 102.

In step 101, a first target object is displayed with a first display parameter at a first time.

Specifically, in the embodiment, a display unit of the electronic device includes two display parameters, i.e., the first display parameter and a second display parameter. When the first target object displayed on the display unit of the electronic device is displayed with the first display parameter, a viewer can perceive that there is a first perceptible distance between the viewer and the first target object.

For example, the electronic device is a 3D television in which a positive DOF adjustment and a negative DOF adjustment are included. In a case that the viewer views a 3D movie with the 3D television, a display parameter adjustment requires to be performed on the display unit of the electronic device. First, if it is determined that the viewer wants to view the 3D movie, the 3D television generates an instruction to control an adjustment module in the 3D television. Then, at a first time, the 3D television adjusts the viewing mode to a 3D viewing mode in which images viewed by the viewer are located between the viewer and the 3D television. Specifically, there are spatial three-dimensional coordinates between the 3D television and the viewer, and the images viewed by the viewer are located between the 3D television and the viewer when the 3D television is in a 3D video playing mode, thereby making the viewer have a viewing experience that the 3D display effect is offered.

In the case that the images viewed by the viewer are located between the 3D television and the viewer, the display unit displays in a positive DOF mode.

In the case that the display unit displays the first target object with the first display parameter at the first time, the electronic device judges whether the electronic device satisfies a first preset condition and generates a first judgment result in real time, where the first preset condition is a condition whether it is satisfied to trigger the electronic device to switch the viewing mode. A switching condition includes that whether first information used for switching the display unit from the first display parameter to the second display parameter is detected by a detection unit in the electronic device detects, and then the electronic device judges the first information and determines whether the electronic device satisfies the first preset condition based on a first judgment result of the first information.

Specifically, in the embodiment, the detection unit may be a feature detection unit capable of detecting feature information of the viewer, such as infrared information, facial images or the viewer's skeleton information. After the feature information is collected, the electronic device judges whether the feature information satisfies the first preset condition, and determines whether there is a need for the display unit of the electronic device to be adjusted from the first display parameter to the second display parameter based on a judgment result.

For example, in a case that the viewer wants to adjust the 3D television from the regular program broadcasting mode to the 3D mode to view a movie, the viewer may make an corresponding action within a detection range of a camera of the 3D television. For example the viewer may make a specific gesture, and the camera of the 3D television may capture the gesture of the viewer; then the 3D television may analyze the gesture and determines whether the gesture satisfies the first preset condition. In a case that the 3D television determines that the gesture satisfies the first preset condition, the 3D television starts the 3D mode and plays the corresponding movie with the 3D display effect.

Of course, in addition to the feature detection, the electronic device may trigger the display parameter switching of the display unit of the electronic device in other ways, such as through a voice control or a remote control. Therefore, by switching the viewing modes in the above way, the operating efficiency of the electronic device may be improved and operations of the viewer may be reduced, thereby making the operation process simpler.

In the case that the electronic device detects there is a need for the display unit to be adjusted from the first display parameter to the second display parameter through the feature detection or in the other ways, the electronic device determines i temporary display parameters in adjusting from the first display parameter to the second display parameter based on the first display parameter and the second display parameter. Of course, a j-th display parameter is included in the i temporary display parameters. When the first target object is displayed with the j-th display parameter, a distance between the first target object and the viewer (i.e., a third distance) which can be perceived by the viewer is equal to a distance between the viewer and the electronic device. In brief, when the first target object is displayed with the j-th display parameter, the first target object viewed by the viewer is located on the display unit, that is, it is in a normal TV viewing mode.

For example, when the 3D television displays the first target object with the j-th display parameter, the viewer may experience a normal 2D viewing effect rather than a 3D viewing effect. That is, the 2D mode has to be experienced in the adjustment process.

After the i temporary display parameters are determined, the electronic device acquires a separation degree in each of the i temporary display parameters, where the separation degree in the i-th temporary display parameter is an i-th separation degree. The separation degree between a first image and a second image in the first target object is adjusted from a first separation degree to the i-th separation degree step by step based on the separation degree in each of the i temporary display parameters to make the first target object adjusted from the first display parameter to the second display parameter step by step.

For example, the 3D television simultaneously displays two images on the display unit (as shown in FIG. 2), i.e., a first image (a left image) and a second image (a right image), where the first image enters into the right eye of the viewer and the second image enters into the left eye of the viewer. Then, the viewer perceives a 3D image when viewing the two images simultaneously.

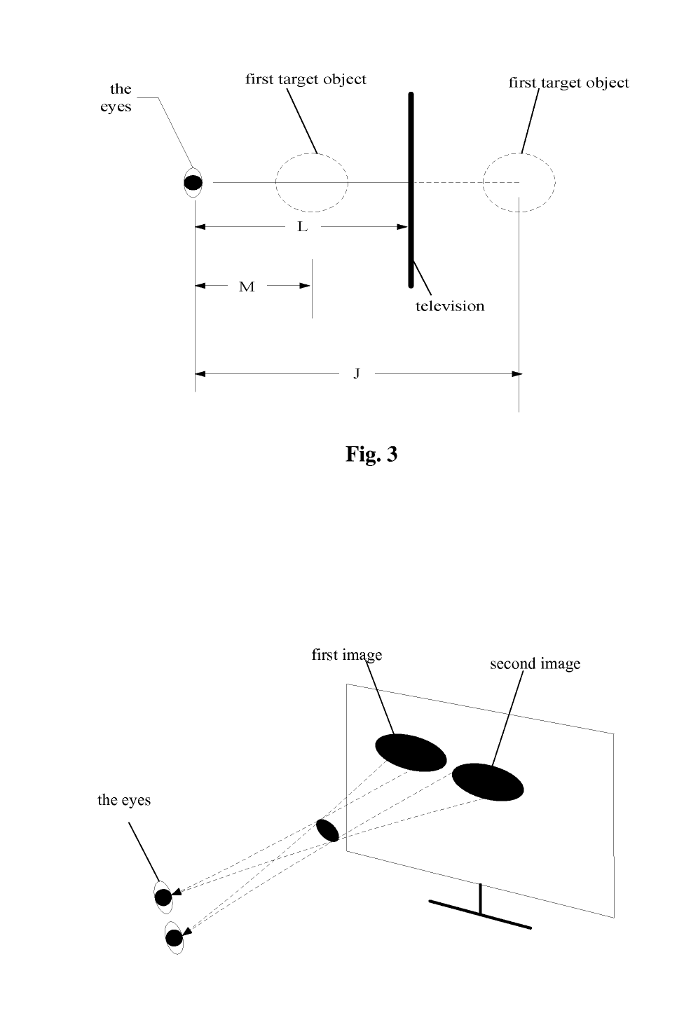

Of course, in order to make the viewer view the 3D image, there has to be a separation degree between the first image and the second image in the first target object displayed on the 3D television (as shown in FIG. 2). In a case that there is the separation degree, the viewer can experience a 3D visual effect from the 3D television. In order to switch the 3D effect of the 3D television in real time, in the embodiment, the 3D television detects that there is a need to adjust from the first display parameter (i.e. a 3D effect of positive DOF) to the second display parameter (i.e. a 3D effect of negative DOF) (as shown in FIG. 3). In FIG. 3, L indicates the third distance between the eyes of the viewer and the display screen of the 3D television, M indicates the second perceptible distance between the viewer and the first target object which is perceived by the eyes of the viewer at the second display parameter, and J indicates the first perceptible distance between the viewer and the first target object which is perceived by the eyes of the viewer at the first display parameter. Then the 3D television determines a target separation degree between the first image and the second image at the second display parameter; and the 3D television further determines an initial separation degree between the first image and the second image at the current first display parameter.

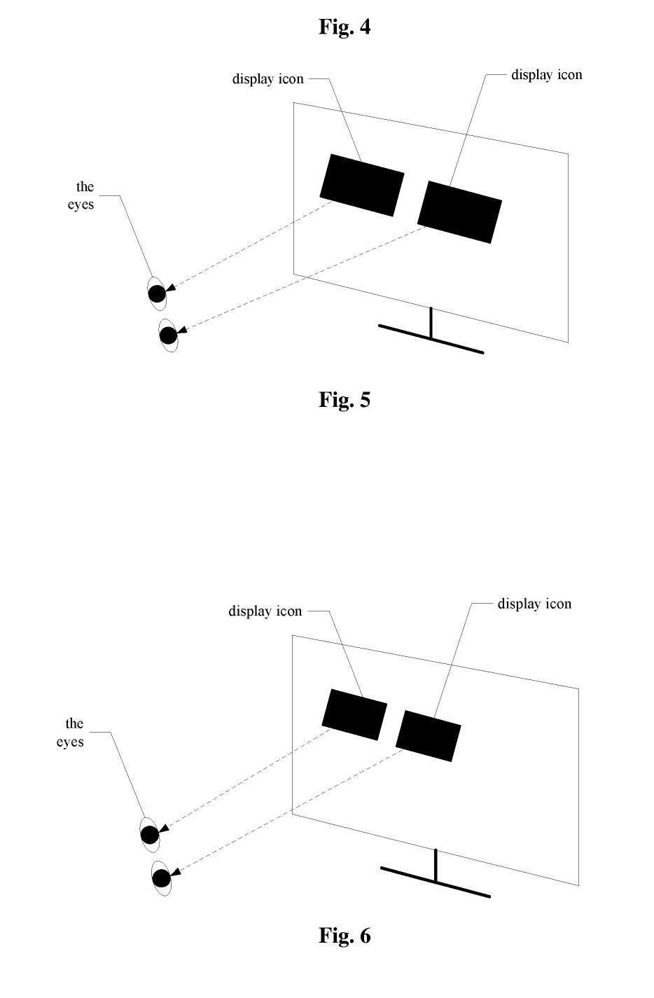

After a current initial separation degree and the target separation degree at the second display parameter are determined, the 3D television determines 40 temporary separation degrees between the initial separation degree and the target separation degree. After the 40 temporary separation degrees are determined, 60 ms are delayed to adjust the separation degree between the first image and the second image to a first temporary separation degree (as shown in FIG. 4). At the first temporary separation degree, a relative distance between the image actually viewed by the viewer and the display unit is increased by 0.25 m. Then, another 60 ms are delayed to adjust the separation degree between the first image and the second image in the first target object to a second temporary separation degree. At the second temporary separation degree, a relative distance between the image actually viewed by the viewer and the display unit is further increased by 0.25 m. Based on the above adjustment way, the 3D television adjusts the display parameter between the first image and the second image in the first target object to achieve the adjustment from the first display parameter to the second display parameter.

Of course, in order to ensure that the 3D television may correctly adjuste to the second display parameter, during the adjustment process, the 3D television judges whether the first target object is displayed with the second display parameter after the preset adjustment step is performed. The 3D television stops adjusting the first target display object if the 3D television displays with the second display parameter; and the 3D television continues adjusting the display parameter until the first target object is adjusted from the current first display parameter to the second display parameter if the first target object is not displayed with the second display parameter.

In the embodiment, by performing switching on multiple display parameters between the first display parameter and the second display parameter step by step, an effect of gentler 3D displaying may be obtained, therefore the viewer can align with the display focus position timely, thereby reducing the difficulty in focusing when the viewer views in 3D mode and enhancing the user experience.

Of course, in order to guide the viewer into the 3D viewing mode more conveniently and more quickly, in the embodiment, the electronic device calls a prestored display icon (as shown in FIG. 5) in addition to adjusting the separation degree between the first image and the second image in the first target object. While adjusting the first target object from the first display parameter to the second display parameter step by step, the prestored display icon is adjusted from a first display mode to a second display mode. That is, the display size of the display icon is reduced (as shown in FIG. 6), thus the viewer can perceive that the first target object is switched from the first perceptible distance to the second perceptible distance. In brief, the electronic device displays the display icon while displaying the first target object, in which the size of the display icon may be adjusted based on the adjustment of the display parameters, therefore the viewer may quickly enter into a 3D viewing state while viewing the size change of the display icon. In the above way, the viewer may quickly enter into the 3D viewing state.

Of course, in the embodiment, the first target object may also be adjusted from the second display parameter to the first display parameter. That is, the first target display object is adjusted from a negative DOF display mode to a positive DOF display mode. Similarly, in the adjustment process, the electronic device determines multiple temporary display parameters between the first display parameter and the second display parameter; and after the multiple temporary display parameters are determined, the electronic device adjusts the first target object from the second display parameter to the first display parameter step by step (as shown in FIG. 3).

For example, in the 3D television or the 3D imaging device, the 3D television determines a positive DOF display parameter and a negative DOF display parameter with which the first target object is displayed, and then determines N temporary display parameters between the positive DOF display parameter and the negative DOF display parameter, and finally adjusts the first target object from the negative DOF display mode to the positive DOF display mode step by step base on the N temporary display parameters. In this process, a preset display icon may also be used, in which the size of the preset display icon may be changed from small to large, thus the viewer may be effectively and quickly guided into the 3D viewing state, the difficulty in focusing when the viewer views a 3D movie or a 3D video is reduced.

Of course, in the embodiment, the adjustment from the first display parameter to the second display parameter may also be an adjustment within the positive DOF range. Here, the adjustment within the positive DOF range is a process in which the viewer may perceive that the first target object is displayed from far to near or from near to far, of course, this process is within the display effect of positive DOF. Alternatively, the adjustment from the first display parameter to the second display parameter may also an adjustment within the negative DOF range, i.e., the adjustment may be a process in which the viewer can perceive that the first target object is displayed from far to near or from near to far, of course, the range of the adjustment is within the adjustment range of negative DOF. That is, when the first target object is displayed with the first display parameter, the viewer may perceive a display effect that the first target object protrudes the display screen; however, if the viewer wants to increase the protrusion effect, the viewer may adjust the display parameter from the first display parameter to the second display parameter with which the display effect that the first target object protrudes the display screen becomes more obvious, thereby improving the 3D experience of the user effectively.

The adjustment of the 3D enhancement effect of the negative DOF is totally the same as the adjustment of the enhancement effect of the positive DOF, which is not repeated here.

After the second display parameter is determined, the electronic device performs step 102.

In step 102, the first target object is displayed with the second display parameter at a second time after the first time.

That is, after adjusting the display parameter of the display unit from the first display parameter to the second display parameter, the electronic device displays the first target object with the second display parameter at the second time after the first time. Of course, before the viewer requires switching the display parameter of the display unit of the electronic device once more, the electronic device keeps displaying the first target object with the second display parameter.

Of course, in addition to the embodiment in the first way, another embodiment is also provided in the disclosure.

### Second Way

In the first way, the electronic device judges whether the electronic device satisfies the first preset condition after step 101 is performed. However, in the second way, the judgment whether the electronic device satisfies the first preset condition is performed before step 101. That is, before displaying the first target object with the first display parameter at the first time, the electronic device judges whether the electronic device satisfies the first preset condition and generates a first judgment result. Once the first judgment result indicates that the electronic device satisfies the first preset condition, the electronic device generates a second execution instruction.

Then, the electronic device performs steps 101 and 102 in response to the second execution instruction.

That is, in step 101, the first target object is displayed with a first display parameter at a first time.

In step 102, the first target object is displayed with a second display parameter at a second time after the first time.

That is, after the second execution instruction is generated, the electronic device displays the first target object with the first display parameter at the first time, and switches from the first display parameter to the second display parameter and displays the first target object with the second display parameter at the second time after the first time, in response to the second execution instruction.

Specifically, in the embodiment, the electronic device firstly judges whether the electronic device satisfies the first preset condition at present. Here, the first preset condition is a condition whether the electronic device is started by the viewer; of course, other first preset conditions may also be used. For example, feature information of the viewer is detected, and it is judged whether the detected information satisfies the first preset condition. Once the first preset condition is satisfied, the electronic device generates an execution instruction. Then, based on the execution instruction, the electronic device displays the first target object with the first display parameter at the first time; next, the electronic device determines the second display parameter, and finally switches the display parameter of the display unit from the first display parameter to the second display parameter. In this way, the viewer may perceive that the distance between the viewer and the first target object is changed from a first perceptible distance to a second perceptible distance, where the first perceptible distance is different from the second perceptible distance.

For example, in the 3D television, the 3D television firstly determines whether a start instruction is received; after the start instruction is received, the 3D television determines a first display parameter (i.e., a 3D effect of positive DOF) and a second display parameter (i.e., a 3D effect of negative DOF), and then determines J temporary display parameters between the first display parameter and the second display parameter; and finally, after the 3D television is started, the first target object is directly displayed with the first display parameter, and then the 3D television performs the adjustment from the first display parameter to the second display parameter step by step based on the J temporary display parameters.

Here, it should be noted that, the judging condition and the mode of the adjustment from the first display parameter to the second display parameter in the second way are totally the same as those in the first way, which are not repeated here.

In addition, in the embodiment, it may be switched from the first display parameter to the second display parameter, or may also be switched from the second display parameter to the first display parameter. For example, it may be switched from the positive DOF to the negative DOF or switched from the negative DOF to the positive DOF. That is, the process in which the viewer perceives that the first target object is displayed from far to near or from near to far is implemented in the same way as the above switching mode, which is not repeated here.

It should be noted that, in the embodiment, the first display parameter and the second display parameter are used to distinguish a display parameter corresponding to the positive DOF and a display parameter corresponding to the negative DOF. However, as for which one of the first display parameter and the second display parameter indicates the display parameter corresponding to the positive DOF or the display parameter corresponding to the negative DOF, it may be determined according to practice and it is not defined in the embodiment.

With the above embodiment, the 3D imaging device may adjust the display unit thereof from the first display parameter to the second display parameter or from the second display parameter to the first display parameter by judging whether the 3D imaging device satisfies a preset condition and a preset switching rule, therefore the viewer may perceive that the distance between the viewer and the first target object is switched between the first perceptible distance and the second perceptible distance. Therefore, the technical problem that the 3D imaging device has a single display mode is solved. Further, for the 3D imaging device, multiple switching modes in 3D imaging are achieved, the display switching modes are increased and the display effect of the 3D imaging device is enhanced.

Further, in the embodiment, the electronic device may also include a first operating mode and a second operating mode, where the first operating mode is different from the second operating mode. The first operating mode corresponds to the first display parameter, and the second operating mode corresponds to the second display parameter. When the first target object is displayed with the second display parameter, the viewer may perceive that the first target object is located between the display unit and the viewer. That is, at the second display parameter, the viewer may obviously perceive a display effect that the first target object protrudes the display unit.

In addition, the second operating mode is an interactive mode in which the electronic device outputs an interactive interface, the interactive interface is configured to prompt the viewer to perform an interactive operation and is capable of receiving the interactive operation of the viewer. The first operating mode is a browse mode in which the electronic device mainly outputs data information, the data information is configured to provide image data to the viewer and is also capable of receiving a default operation of the viewer on the electronic device (for example, an operation of volume adjustment or display lightness adjustment for the electronic device).

The electronic device detects whether there is a first operation in real time. Once there is operation information, the electronic device judges whether the first operation satisfies a second preset condition and generates a second judgment result. In a case that the second judgment result indicates that the first operation satisfies the second preset condition, the electronic device generates a mode switching instruction for controlling the electronic device to switch from the first operating mode to the second operating mode based on the operation information. Based on the mode switching instruction, the electronic device switches from the first operating mode to the second operating mode; further, the electronic device determines the first target object, displays the first target object with the first display parameter at a first time, and displays the first target object with the second display parameter at a second time after the first time.

For example, the electronic device is a 3D television, in a case that the viewer uses the 3D television to view a 3D movie, i.e., the 3D television is in the first operating mode, (the 3D movie may be in a positive DOF display effect or a negative DOF display effect), if the viewer requires calling a control interface of the 3D television, i.e., the 3D television is in the second operating mode, the viewer may make a gesture operation (for example, the viewer moves his/her hand to and fro) within a detection range of a camera of the 3D television. In a case that the 3D television detects the gesture operation of the viewer, the 3D television firstly calls the control interface of the 3D television, and then adjusts the control interface from the first display parameter to the second display parameter. That is, the 3D television adjusts the control interface to being in the 3D display effect of positive DOF, so that the viewer of the 3D television may perceive a display effect that the control interface protrudes the 3D television. Operation icons, such as pause/play, fast forward/fast backward, volume adjustment and other operation icons related with the 3D movie, are displayed on the control interface.

After the control interface is adjusted to the second display parameter, the viewer may perform a control operation at a first space position, then the electronic device judges whether the control operation satisfies a second preset condition. The first space position is located within a preset range of the control interface perceived by the viewer. In brief, the position where the viewer performs the control operation with his/her hand is a position where the control interface perceived by the viewer is located, and the position is located between the viewer and the display unit.

Of course, in the embodiment, it is required to operate at an accurate position on the control interface, and then the 3D television makes a response to the operation. In a case that the viewer performs the control operation on a volume control region of the control interface, the 3D television controls the volume based on the operation of the viewer. It should be noted that, in the embodiment, there may be an offset for the operation position of the viewer, and any operation within an effective offset range may be considered as an effective operation.

Of course, the control interface may also display a control icon unrelated with the 3D movie, for example, the control icon may be a shutdown icon, an application icon, an electronic device status icon and other icons displayed on the display interface of the 3D television.

In addition, after the viewer finishes the interactive operation of the 3D television, the 3D television detects whether there is a second operation of the viewer in real time. The second operation is used for zooming out or shutting down the control interface of the 3D television. In a case that there is the second operation, the 3D television firstly adjusts the control interface from the second display parameter to the first display parameter, i.e., from the positive DOF to the negative DOF. In the process of adjusting the control interface from the positive DOF to the negative DOF, the display scale of the control interface is also reduced, and finally the control interface is displayed with the smallest scale or is directly shut down.

In the above embodiment, by adjusting the display parameters of the control interface, the viewer may perceive a display effect that the control interface protrudes the display unit; and then the viewer may perform an operation at the first space position to achieve a control operation to the electronic device, thus it's achieved that the electronic device adjusts the display parameter of the display control interface. Therefore, the viewer may control the electronic device in space, the control mode and the response speed of the electronic device are improved, and the user experience is enhanced.

In addition, there is another embodiment in the disclosure, that is, the electronic device also includes a first operating mode and a second operating mode. In the first operating mode, the display unit of the electronic device displays the first target object with the first display parameter. For example, a movie is displayed with the first display parameter and the viewer can perceive that the movie is in a positive DOF display effect or a negative DOF display effect. In a case that the viewer wants to switch the electronic device in the first operating mode to the second operating mode, the viewer may control the switching of the operating modes by a preset gesture operation or a remote-control apparatus (such as a remote controller).

In a case that there is a need for the electronic device to switch to the second operating mode, the electronic device determines the second display parameter. After the second display parameter is determined, the electronic device calls a second target object prestored in the electronic device, i.e., the control interface of the electronic device. After the control interface is called, the electronic device adjusts the control interface from the first display parameter to the second display parameter, that is, the control interface is displayed in a manner that the control interface protrudes the display unit, thereby having a positive DOF display effect.

At this time, the viewer may perform an operation at a space position where the control interface is located, and the operation process is the same as the above operation process, which is not repeated here.

After the operation is detected, the electronic device makes a response to the detected operation, for example, the electronic device performs a shutdown operation or a volume adjustment operation.

It should be noted that, the illustration to the electronic device is only illustrated with the 3D television in the embodiment; of course, the method may also be applied to an all-in-one computer, a notebook computer, a mobile phone, a tablet computer and other electronic devices having a data processing function and a display function.

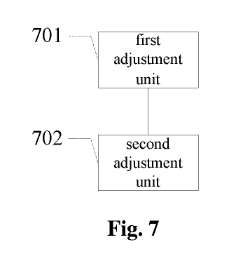

Corresponding to the information processing method according to the embodiment, an electronic device is also provided in an embodiment of the disclosure. Reference is made to FIG. 7 which is a schematic structural diagram of an electronic device according to an embodiment of the disclosure. The electronic device includes a first adjustment unit 701 and a second adjustment unit 702.

The first adjustment unit 701 is configured to display a first target object with a first display parameter at a first time, where a first perceptible distance between the viewer and the first target object is perceptible to the viewer when the first target object is displayed with the first display parameter.

The second adjustment unit 702 is configured to display the first target object with a second display parameter at a second time after the first time, where a second perceptible distance between the viewer and the first target object is perceptible to the viewer when the first target object is displayed with the second display parameter, the first perceptible distance is different from the second perceptible distance.

The electronic device further includes:

a judging unit, configured to judge whether the electronic device satisfies a preset condition and generate a first judgment result;

a first instruction generation unit, configured to generate a first execution instruction in a case that the first judgment result indicates that the electronic device satisfies the preset condition; and

a response unit, configured to display the first target object with the first display parameter at the first time in response to the first execution instruction, and switch from the first display parameter to the second display parameter and display the first target object with the second display parameter at the second time after the first time.

In another electronic device, the second adjustment unit of the electronic device further includes:

a judging module, configured to judge whether the electronic device satisfies a preset condition and generate a first judgment result;

an instruction generation module, configured to generate a second execution instruction in a case that the first judgment result indicates that the electronic device satisfies the preset condition; and

a response module, configured to display a first target object with a first display parameter at a first time in response to the second execution instruction; switch from the first display parameter to the second display parameter and display the first target object with the second display parameter at the second time after the first time, in response to the second execution instruction.

In a case that the electronic device includes a first operating mode and a second operating mode, the electronic device may further include:

an acquisition unit, configured to acquire operation information;

a switching instruction generation unit, configured to generate a mode switching instruction for controlling the electronic device to switch from the first operating mode to the second operating mode based on the operation information;

a switching unit, configured to switch the electronic device from the first operating mode to the second operating mode and display the first target object with the second display parameter based on the mode switching instruction, where the second operating mode can prompt the viewer to perform an operation; and

an adjustment unit, configured to switch the electronic device from the first operating mode to the second operating mode, call a second target object of the electronic device, and adjust the second target object from the first display parameter to the second display parameter, based on the mode switching instruction.

Of course, there is another case. That is, in a case that the electronic device also includes a first operating mode and a second operating mode, the electronic device includes:

a response unit, configured to switch the electronic device from the first operating mode to the second operating mode in response to the second execution instruction; and

a processing unit, configured to adjust the electronic device from the first display parameter to the second display parameter and display the first target object with the second display parameter, based on the second operating mode.

One or more embodiments provided by the disclosure have at least the technical effects or advantages as follows.

In the embodiments of the disclosure, the 3D imaging device can adjust the display unit thereof from the first display parameter to the second display parameter or from the second display parameter to the first display parameter by judging whether the 3D imaging device satisfies a preset condition and a preset switching rule, so that the viewer can perceive that the distance between the viewer and the first target object is switched between the first perceptible distance and the second perceptible distance. Therefore, the technical problem that the 3D imaging device has a single display mode is solved; further, for the 3D imaging device, multiple switching modes in 3D imaging are achieved, the display switching modes are increased and the display effect of the 3D imaging device is enhanced.

In the embodiments of the disclosure, by performing switching on multiple display parameters between the first display parameter and the second display parameter step by step, an effect of gentler 3D displaying may be obtained, therefore the viewer can align with the display focus position timely, thereby reducing the difficulty in focusing when the viewer views in 3D mode and enhancing the user experience.

In the embodiments of the disclosure, by adjusting the display parameters of the control interface, the viewer can perceive a display effect that the control interface protrudes the display unit; and then the viewer can perform an operation at the first space position to achieve a control to the electronic device, therefore, it's achieved that the display parameter of the display control interface is adjusted by the electronic device. Therefore, the viewer can control the electronic device in space, the control mode and the response speed of the electronic device are improved, and the user experience is enhanced.

Those skilled in the art should understand that, the embodiment of the disclosure may be provided as a method, a system or a computer program product. Therefore, the disclosure may adopt an embodiment implemented totally in hardware, totally in software embodiment or in a combination of software and hardware. Further, the disclosure may adopt a form of a computer program product implemented on one or more computer available storage mediums (including but not limited to a disk storage, a CD-ROM, an optical storage or the like) containing a computer available program code.

The disclosure is described based on the flowcharts and/or block diagrams of the method, the device (system), and the computer program product according to the embodiments of the disclosure. It should be understood that, each flowchart and/or block in the flowcharts and/or block diagrams and the combinations of the flows and/or blocks in the flowcharts and/or block diagrams may be implemented by computer program instructions. These computer program instructions may be provided to a processor of a general-purpose computer, a special-purpose computer, an embedded computer, or other programmable data processing devices to generate a machine, so that the instructions executed by the processor of the computer or other programmable data processing devices generate an apparatus for implementing the functions specified in one or more flows of the flowchart and/or one or more blocks of the block diagram.

These computer program instructions may also be stored in a computer readable storage capable of guiding the computer or other programmable data processing devices to operate in a specific way, so that the instructions stored in the computer readable storage generate a manufacture including an instruction apparatus which implements the functions specified in one or more flows of the flowchart and/or one or more blocks of the block diagram.

These computer program instructions may also be loaded onto the computer or other programmable data processing devices, so that a series of operation steps are performed on the computer or other programmable data processing devices to generate a computer implementing process, and the instructions performed on the computer or other programmable data processing devices provide steps for implementing the functions specified in one or more flows of the flowchart and/or one or more blocks of the block diagram.

Obviously, those skilled in the art may make various modifications and variations to the disclosure without departing from the spirit and scope of the disclosure. In this way, provided that these modifications and variations of the disclosure are within the scope of the claims of the disclosure and the equivalent technologies thereof, the disclosure intends to include these modifications and variations therein.

1. An information processing method, comprising:
displaying a first target object with a first display parameter at a first time, wherein a first perceptible distance between a viewer and the first target object is perceptible to the viewer when the first target object is displayed with the first display parameter; and
displaying the first target object with a second display parameter at a second time after the first time, wherein a second perceptible distance between the viewer and the first target object is perceptible to the viewer when the first target object is displayed with the second display parameter, the first perceptible distance is different from the second perceptible distance.

2. The method according to claim 1, wherein the first perceptible distance is less than a distance between the viewer and the display unit and the second perceptible distance is greater than the distance between the viewer and the display unit; or the first perceptible distance is greater than a distance between the viewer and the display unit and the second perceptible distance is less than the distance between the viewer and the display unit.

3. The method according to claim 1, wherein before the displaying a first target object with a first display parameter, the method further comprises:
judging whether the electronic device satisfies a first preset condition and generating a first judgment result;
generating a first execution instruction in a case that the first judgment result indicates that the electronic device satisfies the first preset condition; and
displaying the first target object with the first display parameter at the first time in response to the first execution instruction, and switching from the first display parameter to the second display parameter and displaying the first target object with the second display parameter at a second time after the first time.

4. The method according to claim 1, wherein the displaying the first target object with a second display parameter at a second time after the first time comprises:
judging whether the electronic device satisfies a first preset condition and generating a first judgment result;
generating a second execution instruction in a case that the first judgment result indicates that the electronic device satisfies the first preset condition; and
switching from the first display parameter to the second display parameter in response to the second execution instruction and displaying the first target object with the second display parameter at a second time after the first time.

5. The method according to claim 3, wherein switching from the first display parameter to the second display parameter comprises:
switching from the first display parameter to a third display parameter and switching from the third display parameter to the second display parameter, wherein the third distance between the viewer and the first target object is perceptible to the viewer when the first target object is displayed with the third display parameter, the third distance is a distance between the viewer and the display unit and the third distance is between the first perceptible distance and the second perceptible distance.

6. The method according to claim 3, wherein judging whether the electronic device satisfies a first preset condition comprises:
detecting whether there is a first operation that indicates switching the display unit from the first display parameter to the second display parameter;
judging whether the first operation satisfies the first preset condition and generating the first judgment result; and
generating the first execution instruction which indicates switching from the first display parameter to the second display parameter once the first judgment result indicates that the first operation satisfies the first preset condition.

7. The method according to claim 3, wherein in a case that the electronic device comprises a first operating mode and a second operating mode, the first operating mode corresponds to the first display parameter, the second operating mode corresponds to the second display parameter, and it's perceptible to the viewer that the first target object is located between the display unit and the viewer when the electronic device operates in the second operating mode;
wherein judging whether the electronic device satisfies a first preset condition and generating a first judgment result comprises:
acquiring operation information; and
judging whether the operation information satisfies the first preset condition and generating the first judgment result;
wherein generating a first execution instruction in a case that the first judgment result indicates that the electronic device satisfies the first preset condition comprises:
generating, based on the operation information, a mode switching instruction for controlling the electronic device to switch from the first operating mode to the second operating mode; and
determining the first target object in the electronic device based on the operation information; and
wherein displaying the first target object with the first display parameter at the first time in response to the first execution instruction, and switching from the first display parameter to the second display parameter and displaying the first target object with the second display parameter at the second time after the first time comprises:
switching the electronic device from the first operating mode to the second operating mode based on the mode switching instruction; and
in the process of switching the electronic device from the first operating mode to the second operating mode, displaying the first target object with a first display parameter at the first time and displaying the first target object with a second display parameter at the second time after the first time.

8. The method according to claim 7, wherein after switching the electronic device from the first operating mode to the second operating mode based on the mode switching instruction, the method further comprises:
acquiring, by an image capturing apparatus, a control operation of an operation element at a first space position, wherein the first space position is located within a preset range of the first target object perceived by the viewer;
judging whether the control operation satisfies a second preset condition and generating a second judgment result; and
generating a response to the control operation once the second judgment result indicates that the control operation satisfies the second preset condition.

9. The method according to claim 4, wherein in a case that the electronic device comprises a first operating mode and a second operating mode, the first operating mode corresponds to the first display parameter, the second operating mode corresponds to the second display parameter, and it's perceptible to the viewer that the first target object is located between the display unit and the viewer when the electronic device operates in the second operating mode, switching from the first display parameter to the second display parameter in response to the second execution instruction and displaying the first target object with the second display parameter at a second time after the first time comprises:
switching the electronic device from the first operating mode to the second operating mode in response to the second execution instruction; and
adjusting the electronic device from the first display parameter to the second display parameter and displaying the first target object with the second display parameter based on the second operating mode.

10. The method according to claim 3, wherein displaying the first target object with the first display parameter at the first time, and switching from the first display parameter to the second display parameter and displaying the first target object with the second display parameter at the second time after the first time comprises:
determining i temporary display parameters in adjusting from a first display parameter to a second display parameter based on the first display parameter and the second display parameter;
generating a switching instruction comprising the i temporary display parameters; and
switching the first target object from the first display parameter to the second display parameter step by step based on the switching instruction and the determined i temporary display parameters.

11. The method according to claim 10, wherein switching the first target object from the first display parameter to the second display parameter step by step based on the switching instruction and the determined i temporary display parameters comprises:
calling a display icon prestored in the electronic device; and
adjusting the prestored display icon from the first display mode to the second display mode while adjusting the first target object from the first display parameter to the second display parameter step by step to make the viewer perceive that the distance between the viewer and the first target object is switched from the first perceptible distance to the second perceptible distance.

12. The method according to claim 10, wherein switching the first target object from the first display parameter to the second display parameter step by step based on the switching instruction and the determined i temporary display parameters comprises:
acquiring a separation degree in each of the i temporary display parameters and an i-th separation degree in an i-th temporary display parameter; and
adjusting the separation degree between a first image and a second image of the first target object from a first separation degree to the i-th separation degree step by step based on the separation degree in each of the i temporary display parameters and the i-th separation degree to make the first target object adjusted from the first display parameter to the second display parameter step by step.

13. An electronic device, wherein the electronic device contains or is connected with a display unit, and the electronic device comprises:
a first adjustment unit, configured to display a first target object with a first display parameter at a first time, wherein a first perceptible distance between the viewer and the first target object is perceptible to a viewer when the first target object is displayed with the first display parameter; and
a second adjustment unit, configured to display the first target object with a second display parameter at a second time after the first time, wherein a second perceptible distance between the viewer and the first target object is perceptible to the viewer when the first target object is displayed with the second display parameter, the first perceptible distance is different from the second perceptible distance.

14. The electronic device according to claim 13, further comprising:
a judging unit, configured to judge whether the electronic device satisfies a first preset condition and generate a first judgment result;
a first instruction generation unit, configured to generate a first execution instruction in a case that the first judgment result indicates that the electronic device satisfies the first preset condition; and
a response unit, configured to display the first target object with the first display parameter at the first time in response to the first execution instruction, and switch from the first display parameter to the second display parameter and display the first target object with the second display parameter at the second time after the first time.

15. The electronic device according to claim 13, wherein the second adjustment unit comprises:
a judging module, configured to judge whether the electronic device satisfies a first preset condition and generate a first judgment result;
an instruction generation module, configured to generate a second execution instruction in a case that the first judgment result indicates that the electronic device satisfies the first preset condition; and
a response module, configured to switch from the first display parameter to the second display parameter in response to the second execution instruction and display the first target object with the second display parameter at the second time after the first time.

16. The electronic device according to claim 13, wherein in a case that the electronic device comprises a first operating mode and a second operating mode, the electronic device further comprises:
an acquisition unit, configured to acquire operation information;
a switching instruction generation unit, configured to generate a mode switching instruction for controlling the electronic device to switch from the first operating mode to the second operating mode based on the operation information, and determine the first target object in the electronic device based on the operation information; and
a switching unit, configured to switch the electronic device from the first operating mode to the second operating mode based on the mode switching instruction; and in a process of switching the electronic device from the first operating mode to the second operating mode display the first target object with the first display parameter at the first time and display the first target object with the second display parameter at the second time after the first time.

17. The electronic device according to claim 15, wherein in a case that the electronic device comprises a first operating mode and a second operating mode, the electronic device further comprises:
a response unit, configured to switch the electronic device from the first operating mode to the second operating mode in response to the second execution instruction; and
a processing unit, configured to adjust the electronic device from the first display parameter to the second display parameter and display the first target object with the second display parameter, based on the second operating mode.

18. The method according to claim 4, wherein switching from the first display parameter to the second display parameter comprises:
switching from the first display parameter to a third display parameter and switching from the third display parameter to the second display parameter, wherein the third distance between the viewer and the first target object is perceptible to the viewer when the first target object is displayed with the third display parameter, the third distance is a distance between the viewer and the display unit and the third distance is between the first perceptible distance and the second perceptible distance.
